(19) United States
(12) Patent Application Publication
(10) Pub. No.: US 2002/0063809 A1
(43) Pub. Date: May 30, 2002

(54) Method of providing privacy by temporarily shading or opaquing windows

(76) Inventor: Robin Windell Fletcher, Floyds Knobs, IN (US)

Correspondence Address: Robin Fletcher, Suite 114, 10503 Timberwood Circle, Louisville, KY, 40223, US

(21) Appl. No.: 09/996,090

(22) Filed: Nov. 28, 2001

Related U.S. Application Data
(60) Provisional application No. 60/253,373, filed on Nov. 28, 2000.

(51) Int. Cl. G02F 1/1335

(52) U.S. Cl. 349/16

(57) ABSTRACT

The present invention involves the application of liquid crystal technology to large planar areas through which it is useful to selectively prevent light from passing.

### CROSS-REFERENCE TO RELATED APPLICATIONS

This application claims benefit of No. 60/253,373, filed Nov. 28, 2000, which was filed based upon information disclosed in a Disclosure Document Deposit # 473668, deposited May 8, 2000.

### BACKGROUND OF THE INVENTION

Present methods of shading windows include shades or blinds of cloth, plastic, or other material. A more compact known means of shading windows includes tinting, which involves a layer of semi-opaque film on the window glass to partially block the light from outdoors. However, there is a need for a neat, compact system enabling temporary shading or opaquing of a window. Window opacity would be advantageous to block out light from outdoors during the day, or to block light from escaping a structure during the night. One advantage of such a feature is that persons who work during the night and must sleep during the day are better able to recreate the darkness of night within their home during the day, and can sleep more comfortably. Another advantage of this feature is that it provides privacy. Further, in the evening, those inside a structure can use lighting without necessarily disclosing their presence. None of the heretofore-available methods of window shading are capable of accomplishing these objectives.

### SUMMARY OF THE INVENTION

The present invention accomplishes the aforementioned objectives using liquid crystal technology in a novel application to window shading or tinting. Specifically, using liquid crystal, the present invention provides a method of shading or darkening window glass or other large planar areas to opacity, or varying degrees of opacity, without the use of traditional window treatments or other means external to the window itself. As is known in the relevant art, liquid crystal display systems utilize a small electrical charge to activate transparent electrodes that cause the interposed liquid crystal to scatter light, rendering the view through the electrodes substantially opaque. However, this property of liquid crystal has not heretofore been successfully utilized to address the aforesaid objectives regarding windows or other large planar areas.

Thus, the invention is a method of varying the transparency of large, generally planar areas, comprising a layered system comprising a first hard transparent layer, a first electro-conductive layer, a layer of liquid crystal material a second electro-conductive layer, and a second hard transparent layer, wherein an increased level of opacity of the system is achieved when current is applied across the electro-conductive layers. The large, generally planar area can take the form of a window, a wall, a door, window portions of doors, household appliances, motor homes, and trucks, or any other planar area for which is useful to selectively prevent light from passing through a space. The technology is advantageous in that it is elegant, inexpensive, easy to maintain, and does not present heavy energy demands.

### DESCRIPTION OF THE DRAWINGS

FIG. 1 is a front view of the activated system as applied to windows.

FIG. 1A is a front view of the inactive system as applied to windows.

FIG. 2 is a cross-sectional view of the system of FIG. 1.

FIG. 3 is a cross-sectional view of an alternative embodiment to the system of FIG. 1.

FIG. 4 is a perspective view of an alternative configuration of part 14.

FIG. 5 is a perspective view of the activated system as applied to walls.

FIG. 5A is a perspective view of the inactive system as applied to walls.

FIG. 6 is a cross-sectional view of the system of claim 5.

### DETAILED DESCRIPTION OF THE INVENTION

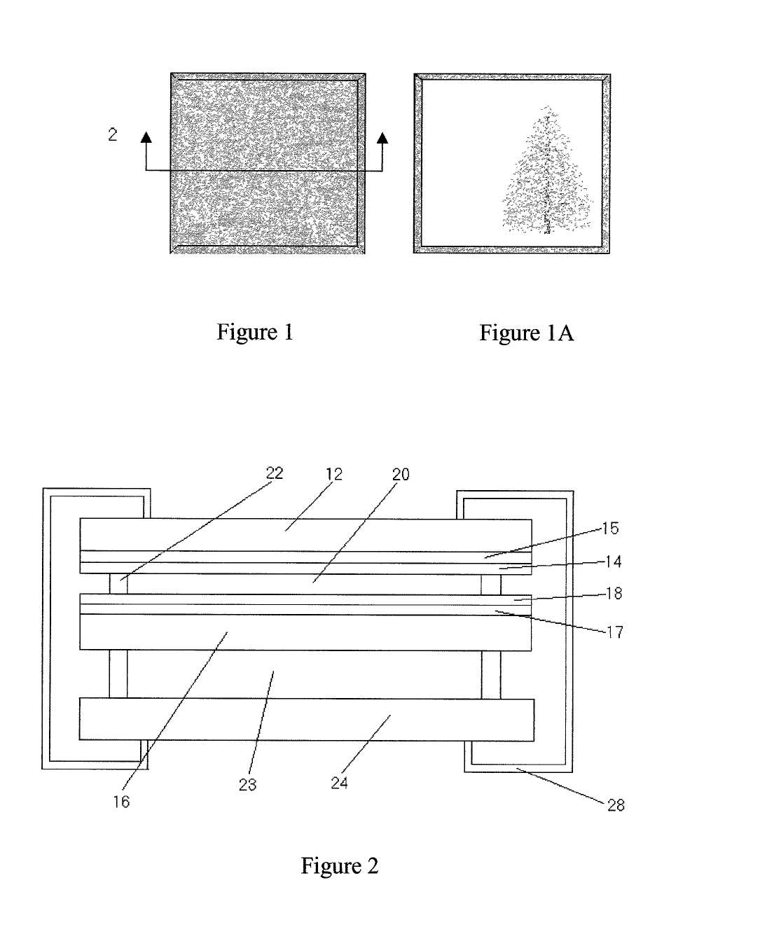

As shown in FIGS. 1 and 1A, the preferred embodiment of the invention as applied to windows preferably involves a standard domestic dwelling or commercial window. A typical home window is about 71×82 cm in size, and a typical commercial window is about 117×142 cm in size. FIGS. 2 and 6 show the liquid crystal system (10, 10A) arranged to include a pair of transparent or translucent outer spaced planar sheets or plates (12, 16), such as glass, fused quartz, transparent varieties or corundum and transparent plastics or resins or a similar substance. For the application of the present invention to windows, the preferred substance for the plates is glass. Adjacent or affixed to each plate is an electrode (14, 18) made of electrically conductive substrate, which is preferably optically conductive as well. The substrate can be made of, for example, indium tin oxide or silicone, which can be deposited on each plate by scattering, evaporation, or in other known ways. A description of such a process can be found in U.S. Pat. No. 3,952,405, herein fully incorporated by reference. Alternatively, the electrically conductive substrate is not optically transmissive itself, but is polarized, and arranged with the appropriately selected intermediate liquid crystal in an optically transmissive way. However, such an arrangement is less preferred when full transparency of the system in the inactive state is desired, because in the inactive state, such a substrate is not fully light transmissive. In order to promote the widest angle of opacity, an electrode may be formed, printed, extruded or molded to have hemispherical, pyramidal, or projectile portions over its surface as shown in FIG. 4 to correspond with another complementarily shaped electrode (not shown). Optionally, electrically non-conductive polarizers (15, 17) or insulative substances such as silicon dioxide can be incorporated into the system (not shown).

The electrode-bearing plates in facing relationship sandwich a thin center layer of a liquid crystal (20). The liquid crystal compositions that may be utilized with the present invention are well known and described in the art. The liquid crystal selected for use should have a long life. As an example, U.S. Pat. No. 3,690,745, fully incorporated herein by reference, describes a liquid crystal and a standard means of electrically connecting electrodes sandwiching the layer of liquid crystal to a source of energy.

Liquid crystal tends to be temperature sensitive. Many liquid crystals do not work properly below about −10 degrees C., or above about 65 degrees C. Thus, in the application of the invention to windows, the liquid crystal layer should be insulated from exposure to temperatures that prevent proper function of the liquid crystal. The prior art for windows addresses the need for insulation by providing two panes of glass, with an insulative vacuum layer between them. As shown in FIG. 2, the present invention involving a liquid crystal system is insulated from temperatures that prevent proper function of the liquid crystal by a vacuum (23), and an additional pane of glass (24). This insulative vacuum layer is spaced and sealed as is known in the art. For the preferred embodiment of FIGS. 1, 1A, and 2, the basic liquid crystal system like that shown in FIG. 6 is exposed on one side to ambient indoor temperatures of a dwelling or other structure, and to the insulative vacuum and glass layer on the other. This allows the liquid crystal to remain within the acceptable operating temperature range in most outdoor temperature conditions. In extremely cold climates, however, it may be desirable to heat the system, for example, by using an electrode that is made of conductive or semi-conductive material that has some resistive, heat generating capacity that would not interfere with the overall function of the system. Similarly, in warm climates, windows exposed to significant sunshine and high temperatures may require additional treatment of the outer pane (24) with a known reflective or filtering coating to prevent the system from overheating.

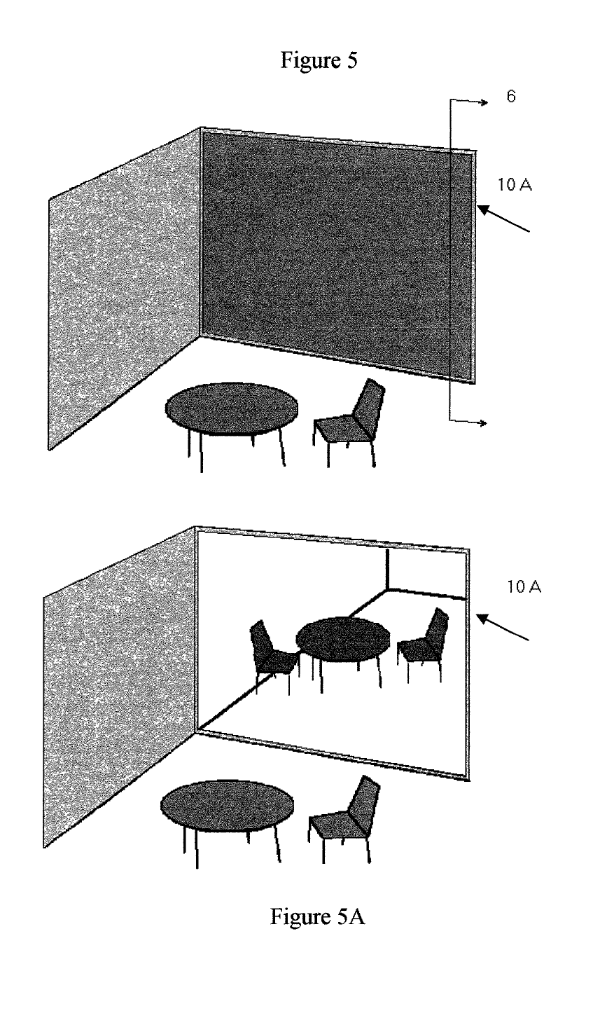

The present invention as applied to interior walls and other large planar areas of a structure as depicted in FIGS. 5, 5A, and 6. Ambient indoor air temperature should always be well within functional operating range of the liquid crystal, and thus, temperature should not create a problem for interior walls. Thus, for interior walls, a third plate and vacuum space should not be required in order to preserve functionality of the liquid crystal. Exterior walls should be treated as windows, above. In the application of the present invention to walls, the plates are preferably made of safer material than ordinary window glass, such as a safety glass or coated glass, or made of other types of transparent or translucent planar substrates known for increased safety properties in the art. One known type of safety glass has imbedded within it a grid of metallic wire, which in addition to providing a safety feature, may also provide additional anti-surveillance features. Further anti-surveillance options will be discussed more fully below.

A seal (22) is provided about the outer periphery of plates (12, 16) to provide a hermetic seal or bond between the plates and encapsulate or enclose the liquid crystal between the electrode-bearing plates. The seal may be applied between the plates in a number of known ways. For a description of some materials that may be used as a seal, and how to form a seal to enclose liquid crystal, see U.S. Pat. No. 3,952,405, fully incorporated herein by reference. The seal is preferably made of a liquid-impermeable substance with generally adhesive qualities, such as, for example, any long life thermosetting polymeric substance of this general description that does not degrade with exposure to liquid crystal. The seal is applied proximate the inside edges of the electrode-bearing plates, and the entire arrangement is heated until the seal flows. Alternatively, a polymeric material that sets over a period of time can be used, or ultrasonic sealing or other methods to seal the planes as well. The cavity encapsulating the liquid crystal may be filled through pre-fabricated gaps in the seal or in the plates, by capillary action, or by use of a hypodermic needle through the seal, for example. Use of vacuum may be required in order to entirely fill the cavity without leaving air pockets. An example of a method of sealing liquid crystal is disclosed in U.S. Pat. No. 3,990,782, fully incorporated herein by reference.

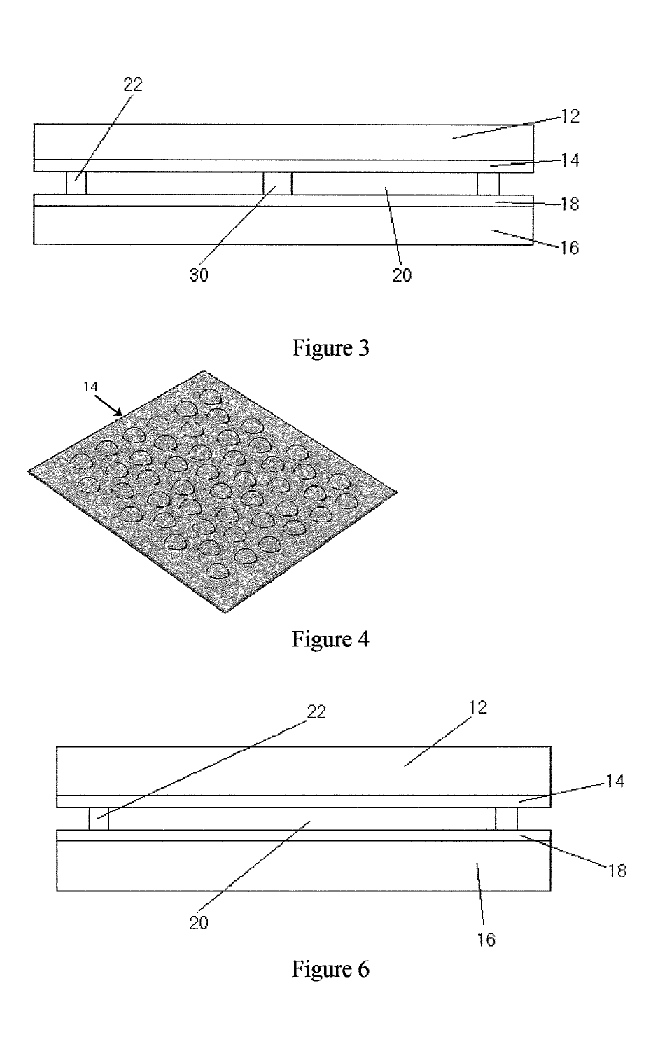

The preferred distance maintained between the electrodes (14, 18), on either side of the liquid crystal is between 0.00025 and 0.125 cm, and more preferably between 0.0007 and 0.004 cm, but may vary outside of these suggested distances. The amount of liquid crystal that would be required to fill the volume between the two system plates of a 71×82 cm window to the preferred thickness would be roughly 4.1 ml to 23 ml. As shown in FIG. 3, spacers (30) may be necessary to help maintain the distance between the electrodes flanking the liquid crystal under conditions where stabilization of the space provided to encapsulate the liquid crystal is required to prevent the gap between electrodes from becoming overly thin or closing. The use of spacers is preferred when the system (10, 10A) extends beyond a distance of about 71×82 cm. The spacers are preferably made of the same polymeric substance as the seal.

Overall, the advantage to using clear rather than opaque material in the spacers is the difference in overall transparency when the system is in its most transparent (inactive) state. Unless polarizers are used, the opacity of the system is limited to the extent that light can be perceived through the spacer material. Use of very small spacers, however, can limit the amount of light penetrating the system, while compromising to some extent the goal of stabilization of the distance between the two electrodes. In anti-surveillance applications, for example, or other situations in which total opacity may be desired, the spacers are preferably opaque. The overall effect is thus greater opacity in the activated state, with the consequence that the spacers will be visible and non-transparent when the system is in the transparent state. Likewise, the opaque spacers may be of smaller sizes with the resultant compromise in stability.

As shown in FIGS. 1 and 1A, and 5 and 5A, the arrangement of plates, electrodes, optionally polarizers and/or insulators, and liquid crystal create the appearance of opacity when an electrical field is activated across the electrodes. The electrical field causes the molecules in the liquid crystal composition to scatter in such a way that an opaque appearance results. In order to create an electrical field, the electrodes are suitably connected to an electromotive force (emf) (not shown) as described above. The electrical connectors (not shown) can be housed in a frame (28) surrounding the edge of the system, shown in FIG. 2, or in the walls or a frame adjacent the system in FIGS. 5 and 5A.

The emf can output AC or DC power. The type of power should be selected based upon what is most appropriate for the location and use of the system. If the emf is a D/C battery source, the system preferably provides for an accessible compartment (not shown) housing a battery, that would be periodically changed, as necessary. The system may also be powered at least partially by solar energy. This requires that solar panels be mounted in an arrangement either indoors or outdoors, so as to utilize the power from the sun or the interior lighting. The preferred location of the solar panels depends both upon the power requirements of the system, and the corresponding size of panels required to supply that power. Solar power collector cells located outdoors should utilize storage cells to allow continued power supply for several hours after lighting conditions diminish. The electrical energy or impressed voltage through the liquid crystal must be sufficient to reach or exceed the threshold voltage at which the crystal composition will scatter light. For layers of about 1 mm thickness, this threshold voltage is about 6 volts. The power dissipation for an activated condition for a 1.0 cm² is approximately 30 microwatts. Thus, a window sized about 71×82 cm draws about 175 milliwatts of power per hour. Solar power can generate about 7-12 milliwatts per cm² of solar paneling per hour. Thus, a solar panel of about 5×6 cm to about 7×7 cm could power two 71×82 cm sized windows, which together would draw 349 milliwatts, in a system having a liquid crystal layer 1 mm thick. However, the preferred width between the electrodes of this invention is less than 1 mm, and thus the corresponding voltage requirements are lower.

In many cases, full power need not be continuously applied, since many liquid crystals exhibit some retention of form in that they continue to exhibit dynamic scattering for a period of time after voltage is removed. Thus, liquid crystal can remain continuously opaque with only intermittent application of voltage. Also, liquid crystals are known in the art that have a memory such that once an image is formed, it is retained without any maintaining power until dissipated with a separate cue. Use of such a liquid crystal in the present systems would greatly reduce power requirements. Liquid crystals having this characteristic have been described, for example, in Heilmeier and Goldmacher, Proc. of the IEEE, 57, No. 1, January 1969, pp. 34-38, and have been referred to in U.S. Pat. No. 3,938,318, both fully incorporated herein by reference.

Selective activation of small areas of the system can be accomplished by etching or otherwise arranging electrodes to the extent that one electro-conductive layer of the system is composed of columns of electrodes, and one of rows, the electrodes being in perpendicular arrangement. Formation of passive and active matrix systems are well known, and readily taught in the current art. Use of integrated circuits and a processor are contemplated to control selective activation of rows and columns of electrodes in this invention, which allows selective gradations of shading between the conditions of transparency and opacity. Where the proportion of selected small, spaced apart, activated areas of liquid crystal increases, the overall opacity of the system is increased incrementally. Highly specific variation of the strength of the emf voltage applied across the electrodes may aid in activating parts or all of the system to varied shading levels in a gradual, rather than an incremental fashion.

A variable switch or other known means may be used to achieve this variation of the voltage affecting transparency of the window. Also, the treated system may be touch-activated as is known in the lighting industry, the touch sensor optionally comprising a frame (28), a pad, or button about or adjacent the system. Touch-activation and/or a variable switch can optionally be combined with a passive matrix system to smoothly or in set gradations or increments vary opacity of the system (10, 10A).

An additional optional feature encompassed in the most preferred embodiment incorporating the passive matrix system is the use of colored liquid crystal display technology.

Passive matrix systems designed to transmit color such as those using color super-twist nematics (CSTN) and dual scan STN (DSTN) and high performance addressing (HPA) technologies, as described in current literature in those art areas, are also known and contemplated for use in this invention, but require more power. Incorporating an active matrix liquid crystal display utilizing thin film transistors is also contemplated as another colorful alternative in the present invention, but at present, is not preferred due to the expense of such systems.

The application of colored liquid crystal display to the present invention allows for decorative advantage. Decorative design patterns for the colored liquid crystal display system may reside on a fixed or removable computer chip. Such designs can alternatively resemble a view from an ordinary transparent window, or a work of art, or another image. Windows, walls, or other large planar areas utilizing liquid crystal technology can be fashioned to be of the same color as the surrounding walls, causing them to be inconspicuous, or imperceptible with use of special glass coatings or etchings, if desired. Use of integrated circuits can allow variation in the image displayed on the window system.

In many applications of the current invention, it may be advantageous to include additional anti-surveillance features in addition to visual obstruction. Optionally, in an anti-surveillance application of an embodiment discussed above, the system may also include two sets or layers of parallel electro-conductors, such as wires, the sets being in perpendicular arrangement, so as to prevent electrical transmission of data through the system. Such a grid can be formed with simple electrical wire, molded into a plate such as glass as known in the art, outside the plate, or in layers with the other substances in the system, so long as it does not influence the electrical function of the electrodes. Linear electro-conductive gridlines could also be formed by known thin film and/or photo-masking or other techniques of creating polarized patterns, and could serve as the electrodes in the system, as described above. For a description of an example of known photomasking and thin film techniques, see U.S. Pat. No. 3,963,312, fully incorporated herein by reference. Optionally, the linear electro-conductors may also be resistive to the extent that they generate heat while conducting electricity. The preferred heat generated would be in the range of 25-40 degrees C. so as to discourage transmission of human infrared information.

The scope of this invention is not limited to strictly planar areas, but would be beneficial in certain controlled situations in vehicular windows. However, in such an embodiment, the liquid crystal will be exposed to extreme temperatures without constant benefit of moderating temperatures from within the vehicle. Hence, the temperature moderating means described above would be necessary in such a system. Application of the system to vehicular windows would also raise safety concerns with respect to the possible accidental or unintentional obstruction of the operator's view. Visual obstruction by activation of the system can be prevented while the vehicle is in operation, or while it is in gear, by any of a number of known electrical or mechanical means. The ability to opaque and/or tint or color the windows of a vehicle could be an important safety feature, by disabling outsiders from determining the contents, or presence of occupants within a vehicle. Additional benefits would include maintaining a cooler internal temperature within the vehicle, and preventing the contents of the vehicle from fading. Use of integrated circuits in a passive or active matrix display, preferably a passive display to spare expense, can enable alternative images to be displayed on the window system, including words, trademarks, or designs. This could provide an important safety feature for stranded motorists, and it is contemplated that computer or other means to input information for display would be even more useful.

I claim:

1. A method of varying the transparency of large, generally planar areas, comprising:
Arranging a system of layers in parallel relation, the layers including a first transparent plate, a first electro-conductive layer, a layer of liquid crystal material, a second electro-conductive layer, a second transparent plate, and
Applying current across the electro-conductive layers, resulting in an increased level of opacity of the system,
Where the large, generally planar area is a window.

2. The method of claim 1, wherein said system further includes two sets of parallel electro-conductive wires in perpendicular arrangement, so as to prevent transmission of electrical information through the system.

3. The method of claim 1, wherein said first electro-conductive layer has a surface arrayed with projective forms and said second electro-conductive layer has a complementarily shaped surface.

4. The method of claim 1, wherein said system further includes a polarized filter layer on either side of the liquid crystal layer.

5. The method of claim 1, wherein said first electro-conductive layer comprises columns of an electro-conductive substance, and said second electro-conductive layer comprises rows of an electro-conductive substance perpendicular to said first electro-conductive layer.

6. A method of varying the transparency of large, generally planar areas, comprising:
Arranging a system of layers in parallel relation, the layers including a first transparent plate, a first electro-conductive layer, a layer of liquid crystal material, a second electro-conductive layer, a second transparent plate, and
Applying current across the electro-conductive layers, resulting in an increased level of opacity of the system,
Where the large, generally planar area is a window.

7. The method of claim 6, wherein said system further includes two sets of parallel electro-conductive wires in perpendicular arrangement, so as to prevent transmission of electrical information through the system.

8. The method of claim 6, wherein said first electro-conductive layer has a surface arrayed with projective forms and said second electro-conductive layer has a complementarily shaped surface.

9. The method of claim 6, wherein said system further includes a polarized filter layer on either side of the liquid crystal layer.

10. The method of claim 6, wherein said first electro-conductive layer comprises columns of an electro-conductive substance, and said second electro-conductive layer comprises rows of an electro-conductive substance perpendicular to said first electro-conductive layer.

11. A layered system covering a large, generally planar area, comprising a first transparent plate, a first electro-conductive layer, a layer of liquid crystal material, a second electro-conductive layer, and a second transparent plate, wherein an increased level of opacity of the system is achieved when current is applied across the electro-conductive layers, and said large, generally planar area is a window.

12. The system of claim 11, wherein said system further includes two sets of parallel electro-conductive wires in perpendicular arrangement, so as to prevent transmission of electrical information through the system.

13. The system of claim 11 wherein said first electro-conductive layer has a surface arrayed with projective forms and said second electro-conductive layer has a complementarily shaped surface.

14. The system of claim 11, wherein said system further includes a first and second polarized filter layer on either side of the liquid crystal layer.

15. The system of claim 11, wherein said first electro-conductive layer comprises columns of an electro-conductive substance, and said second electro-conductive layer comprises rows of an electro-conductive substance perpendicular to said first electro-conductive layer.

16. A layered system covering a large, generally planar area, comprising a first transparent plate, a first electro-conductive layer, a layer of liquid crystal material, a second electro-conductive layer, and a second transparent plate, wherein an increased level of opacity of the system is achieved when current is applied across the electro-conductive layers, and said large, generally planar area is a wall.

17. The system of claim 16, wherein said system further includes two sets of parallel electro-conductive wires in perpendicular arrangement, so as to prevent transmission of electrical information through the system.

18. The system of claim 16, wherein said first electro-conductive layer has a surface arrayed with projective forms and said second electro-conductive layer has a complementarily shaped surface.

19. The system of claim 16, wherein said system further includes a first and second polarized filter layer on either side of the liquid crystal layer.

20. The system of claim 16, wherein said first electro-conductive layer comprises columns of an electro-conductive substance, and said second electro-conductive layer comprises rows of an electro-conductive substance perpendicular to said first electro-conductive layer.

21. A layered system covering a large, generally planar area, comprising a first transparent plate, a first electro-conductive layer, a layer of liquid crystal material, a second electro-conductive layer, and a second transparent plate, wherein an increased level of opacity of the system is achieved when current is applied across the electro-conductive layers, and said large, generally planar area is a door.
